(19) United States
(12) Patent Application Publication
(10) Pub. No.: US 2012/0272281 A1
(43) Pub. Date: Oct. 25, 2012

(54) METHOD AND APPARATUS FOR TRANSMITTING MEDIA DATA, AND METHOD AND APPARATUS FOR RECEVING MEDIA DATA

(75) Inventors: Ho-jin Ha, Suwon-si (KR); Soon-back Cha, Hwaseong-si (KR); O-hoon Kwon, Suwon-si (KR); Hyung-tak Choi, Suwon-si (KR); Sun-bal Kim, Suwon-si (KR); Ji-eun Keum, Suwon-si (KR)

(73) Assignee: SAMSUNG ELECTRONICS CO., LTD., Suwon-si (KR)

(21) Appl. No.: 13/403,653

(22) Filed: Feb. 23, 2012

(30) Foreign Application Priority Data
Apr. 22, 2011 (KR) 10-2011-0037984

(51) Int. Cl. H04N 21/60; H04N 21/20

(52) U.S. Cl. 725/110; 725/109; 725/116

(57) ABSTRACT

An information file pertaining to media data includes reproduction rating information for each of a plurality of segments. The information file is used by a client to determine what segment or segments to request from a server. The server responds to the request by sending the segment or segments to the client. Since the reproduction rating information may be provided for each of the segments, the selection of the segment or segments by the client can take into account a reproduction rating threshold.

### CROSS-REFERENCE TO RELATED PATENT APPLICATION

This application claims the benefit of Korean Patent Application No. 10-2011-0037984, filed on Apr. 22, 2011, in the Korean Intellectual Property Office, the disclosure of which is incorporated herein in its entirety by reference.

### BACKGROUND

1. Field

The inventive concept relates to a method and apparatus for transmitting media data and a method and apparatus for receiving media data, and more particularly, to a method and apparatus for transmitting media data and a method and apparatus for receiving media data according to reproduction rating information pertaining to each of a plurality of segments forming media data.

2. Description of the Related Art

Parents have an increasing need to supervise what their children watch, since the development of information technology has made various types of media data instantly and easily accessible.

In order to satisfy a users' request, a server may regenerate media data that has a reproduction rating (i.e., an indication of the minimum audience maturity level) by eliminating a part of original media data which is not in accordance with a predetermined reproduction rating that may have been established, and provides the regenerated media data to a user.

Although the user may easily obtain the media data that matches a reproduction rating desired by a user, it has been uneconomical for the server to generate a plurality of pieces of media data, one for each of several reproduction ratings, respectively.

### SUMMARY

The inventive concept provides a method and apparatus for transmitting media data and a method and apparatus for receiving media data according to reproduction rating information pertaining to each of a plurality of segments.

According to an aspect of the exemplary embodiments, there is provided a method of transmitting media data formed of a plurality of segments. An information file relating to the media data is prepared. The information file includes reproduction rating information for each of the plurality of segments. The information file is transmitted to a client. The server receives from the client a transmission request for a segment or segments. In response to the transmission request, the requested segment or segments are transmitted to the client.

The media data may be one of a plurality of pieces of media data generated by encoding a particular input content so as to have differing quality levels, and the information file may include information pertaining to each of the several pieces of media data.

The reproduction rating information may include location information that pertains to a period where the reproduction rating in the media data is all the same, and an indication of the reproduction rating pertaining to that period.

The reproduction rating information may, in an exemplary embodiment, include only location information in the media data pertaining to a period that has a reproduction rating equal to or greater than a threshold value.

The location information may include identification information pertaining to a first segment and a last segment in the period.

The location information may include time information that indicates start and end times of the period.

The start of the period may be a random access point.

The reproduction rating information may be commonly applied to the plurality of pieces of media data.

The reproduction rating information may include identification information pertaining to the media data to which the reproduction rating information is to be applied.

According to another aspect of the inventive concept, there is provided a method of receiving media data. The media data is received as a plurality of segments. In this method, a client receives an information file pertaining to the media data. The information file includes reproduction rating information for each of the segments that can be received from the server. Based on the information file, the server is requested to transmit a segment or segments selected from among the plurality of segments. The requested segment or segments are received from the server.

According to another aspect of the inventive concept, there is provided a data transmitting apparatus for transmitting media data formed of a plurality of segments. The apparatus includes an information file transmitting unit that transmits an information file pertaining to the media data. The information file includes reproduction rating information for each of the plurality of segments. The information file is transmitted to a client. The apparatus also includes a request receiving unit. This unit receives transmission requests from clients. These requests relate to at least one segment. The apparatus also includes a segment transmitting unit that transmits the requested segment or segments to the client, in response to the transmission request.

According to another aspect of the inventive concept, there is provided a data receiving apparatus. The apparatus receives media data formed from a plurality of segments, and includes an information file receiving unit. This unit receives an information file pertaining to the media data and it includes reproduction rating information for each of the plurality of segments. The information file is received from a server. The apparatus also includes a request unit for requesting the server to transmit a selected segment or segments from among the plurality of segments. The selection is based at least in part on the information file. The apparatus also has a segment receiving unit that receives the segment or segments from the server.

### BRIEF DESCRIPTION OF THE DRAWINGS

The above and other features and advantages of the inventive concept will become more apparent by describing in detail exemplary embodiments thereof with reference to the attached drawings in which:

FIG. 1 is a diagram of a streaming system according to an exemplary embodiment;

FIGS. 2A and 2B are flowcharts for describing streaming methods according to exemplary embodiments;

FIG. 3 is a schema of a file including information about content, according to an exemplary embodiment;

FIG. 4A illustrates information for defining a plurality of pieces of media data, according to an exemplary embodiment;

FIG. 4B illustrates information about a header of media data, according to an exemplary embodiment;

FIG. 4C illustrates information about at least one segment included in each of a plurality of pieces of media data, according to an exemplary embodiment;

FIGS. 5A and 5B are flowcharts for describing streaming methods according to other exemplary embodiments;

FIG. 6 is a schema of a file including information about content, according to another exemplary embodiment;

FIG. 7 illustrates information about content according to an exemplary embodiment;

FIGS. 8A and 8B are schemas of a media presentation description according to exemplary embodiments;

FIGS. 9A through 9H illustrate media presentation descriptions according to exemplary embodiments;

FIGS. 10A through 10C each illustrate a plurality of pieces of media data according to exemplary embodiments;

FIGS. 11A and 11B are flowcharts for describing streaming methods according to other exemplary embodiments;

FIGS. 12A and 12B each illustrate a plurality of pieces of media data according to other exemplary embodiments;

FIG. 13 is a block diagram of a data transmitting apparatus according to an exemplary embodiment;

FIG. 14 is a block diagram of the data receiving apparatus according to an exemplary embodiment;

FIG. 15 illustrates an information file pertaining to media data, according to an exemplary embodiment;

FIG. 16 illustrates an information file pertaining to media data, according to another exemplary embodiment;

FIG. 17 illustrates an information file pertaining to media data, according to another exemplary embodiment;

FIG. 18 illustrates an information file pertaining to media data, according to another exemplary embodiment;

FIG. 19 illustrates an information file pertaining to media data, according to another exemplary embodiment; and

FIG. 20 is a flowchart of operations of a data transmission system, according to an exemplary embodiment.

### DETAILED DESCRIPTION

Hereinafter, the inventive concept will be described in detail by explaining exemplary embodiments with reference to the attached drawings.

For the sake of convenience of description, some of the terms that are used in the detailed description are briefly defined, although these definitions should not be interpreted in a severely limiting manner.

Examples of content include audio information, video information, audio-video information, and data. The content may be multimedia data formed of a plurality of components.

The components indicate audio information, video information, subtitle information, or the like which form the content. For example, multimedia content may include components such as a subtitle stream generated by using a particular language, and a video stream obtained at a particular camera angle. Each component may be called a track or an elementary stream (ES) according to a container.

A period indicates a temporal section of a content resource.

A representation indicates media data presented in the period, and is formed of one or more components. In representations, sub-sets of components may be different, or encoding parameters (e.g., a bit rate) of components may be different. In the present description, although the representation refers to media data, any term indicating data including one or more components may refer to the media data.

A segment indicates a temporal section of the representation which is referred to by a unique Uniform Resource Locator (URL) in a specific system layer format (e.g., TS or MP4).

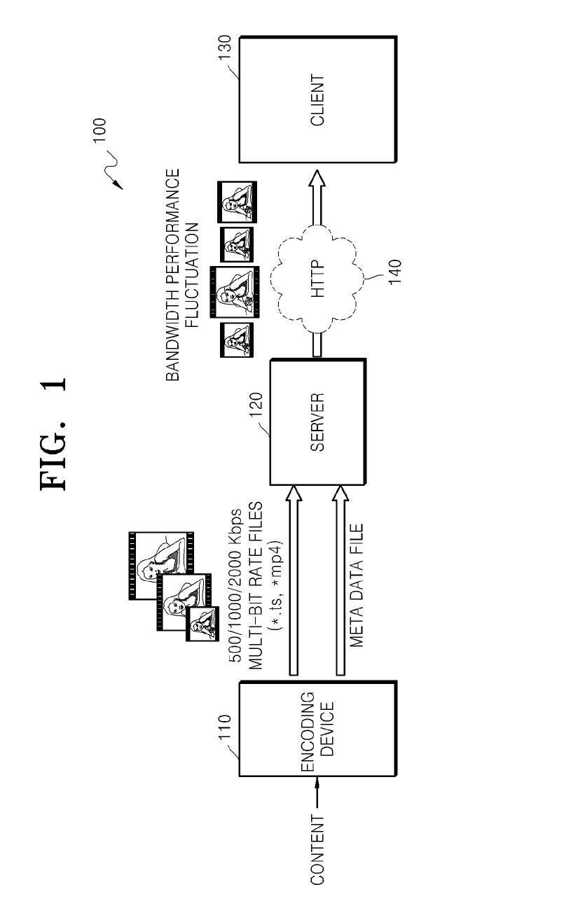

FIG. 1 is a diagram of a streaming system 100 according to an exemplary embodiment.

Referring to FIG. 1, the streaming system 100 according to the current exemplary embodiment includes an encoding device 110, a server 120, and a client 130.

The encoding device 110 generates a plurality of pieces of media data related to one input content. The generation of the media data is done by encoding the input content so as to obtain media in a plurality of different quality levels. The reason for the multiple quality levels is that the streaming environment may change while the server 120 streams media data to the client 130. For example, the bandwidth of the network 140 may change, or the hardware source used by the server 120 to transmit media data (or by the client 130 to receive media data) may change.

Accordingly, the encoding device 110 encodes one input content to have different qualities for adaptive streaming according to a fluidic streaming environment. One input content may be encoded to have different quality levels (also referred to as, simply, qualities) by adjusting a factor such as the bit rate, the sampling frequency, the resolution, or the frame rate. For example, a plurality of pieces of media data in 500 Kbps, 1000 Kbps, and 2000 Kbps may be generated by encoding one input content in different resolutions.

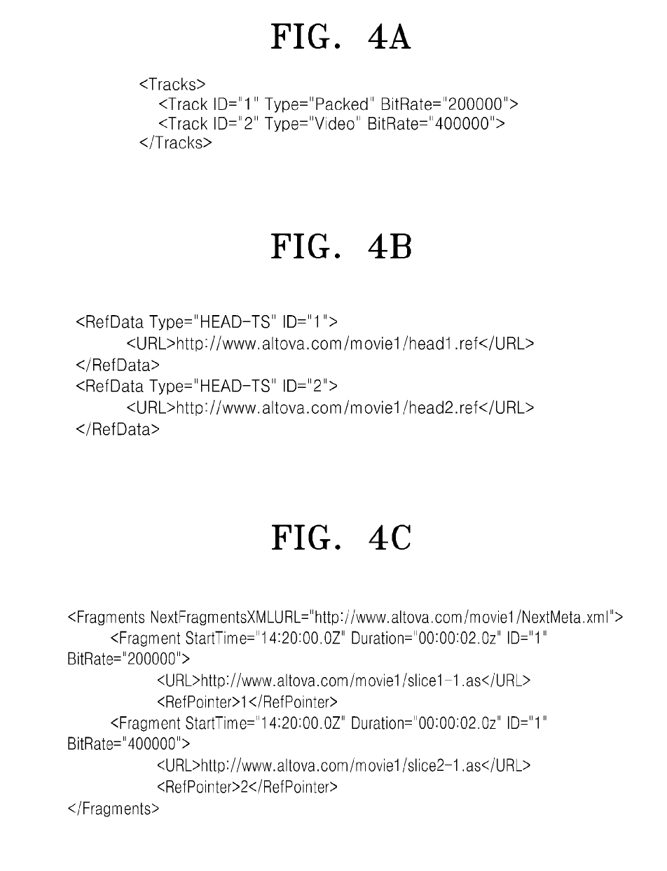

The plurality of pieces of media data in different qualities are transmitted to the server 120 and, at this time, information about the content and information about each media data may also be transmitted to the server 120. The information about the content may include, as metadata of the content, information about the title, a synopsis, a content identifier (ID), and a content uniform resource locator (URL) of the content. The information about each media data may include a quality, a type, an ID, or the like for each of the generated media data, and will be described in detail with reference to FIGS. 4A through 4C.

The client 130 receives the information about the content and/or information about each media data, and requests from the server 120 for at least one of the plurality of pieces of media data, based on the information that was received. The client 130 estimates a streaming environment, and selects at least one of the plurality of pieces of media data based on the estimate. The selection may be based, for example, on which media data may be used to maintain a suitable quality of service (QoS) within the estimated streaming environment. Then, the client 130 may transmit a hypertext transfer protocol (HTTP) request requesting the server 120 to transmit the selected media data.

When the streaming environment deteriorates, and the quality of media data in the process of being received cannot be continuously reproduced, lower quality media data may be requested, assuming that it is available among the plurality of pieces of media data that were generated by encoding device 110. When the streaming environment improves, and lower quality media data is being received but continuous reproduction of higher quality media data is possible, the client 130 may again request to receive high quality media data.

The client 130 may request the server 120 to transmit another media data while receiving a predetermined media data. For example, the client 130, which requested and was receiving first media data that is of low quality in a deteriorated streaming environment, may request the server 120 to transmit second media data that is of higher quality than the first media data when the streaming environment improves. According to one method, when the server 120 and the client 130 set an initial quality level while initially setting up a streaming channel, the media data is continuously transmitted and received at that same quality. However, according to the current exemplary embodiment, streaming that is adaptive to the streaming environment is possible since the client 130 is able to request for the second media data again even while receiving the first media data about the same content.

The client 130 may estimate a streaming environment by using any method of estimating a streaming environment, taking into account the bandwidth of the network 140 and/or the hardware resources that may be used by the server 120 or the client 130. For example, the client 130 may estimate the streaming environment based on a time stamp and a bit error rate (BER) of received media data. The streaming environment may be determined to be deteriorated when media data is received slower than the reproduction speed. This may be checked by checking the time stamps of the received media data. Alternatively, the streaming environment may be determined to be deteriorated when the bit error rate (BER) of the received media data increases.

When the client 130 requests the server 120 to transmit at least one of the media data according to the streaming environment, the server 120 transmits requested media data to the client 130. The server 120 may transmit the requested media data to the client 130 as an HTTP response to an HTTP request.

Each media data may include at least one of a plurality of segments generated by encoding content in different quality levels, and dividing the encoded content. In other words, each media data generated by encoding the content at the encoding device 110 may be divided on a time basis so that they include one or more segments. The server 120 transmits the content in segments, instead of a continuous stream. The plurality of segments may be generated by dividing the content into predetermined time units, such as units of 10 or 20 seconds. The time that is the basis for dividing the content may be set based on a group of pictures (GOP). Media data corresponding to pictures of one or more GOPs may be set as one segment.

For example, when content being streamed is available in two qualities, a first media data may include at least one segment generated by encoding the content to have a first quality and dividing the encoded content based on time, and a second media data may include at least one segment generated by encoding the content to have a second quality and dividing the encoded content based on time. Here, in this example, the first media data has a lower respective quality and the second media data has a respective quality higher than that of the first.

In this example, adaptive streaming is implemented by taking advantage of the segments which represent the time-divided, encoded data. For example, when streaming starts, the server 120 may transmit a segment corresponding to from 0 to 20 seconds of the first media data (i.e., the lower quality data). Then, when it is determined that the streaming environment can support the higher quality data, the client 130 requests the second media data that is of higher quality. In response, the server 120 may transmit a segment corresponding to 20 to 40 seconds of the higher quality second media data (i.e., the next 20 seconds). Since the media data is divided into a plurality of segments based on time, segments of different media data may be transmitted according to a streaming environment, even during streaming.

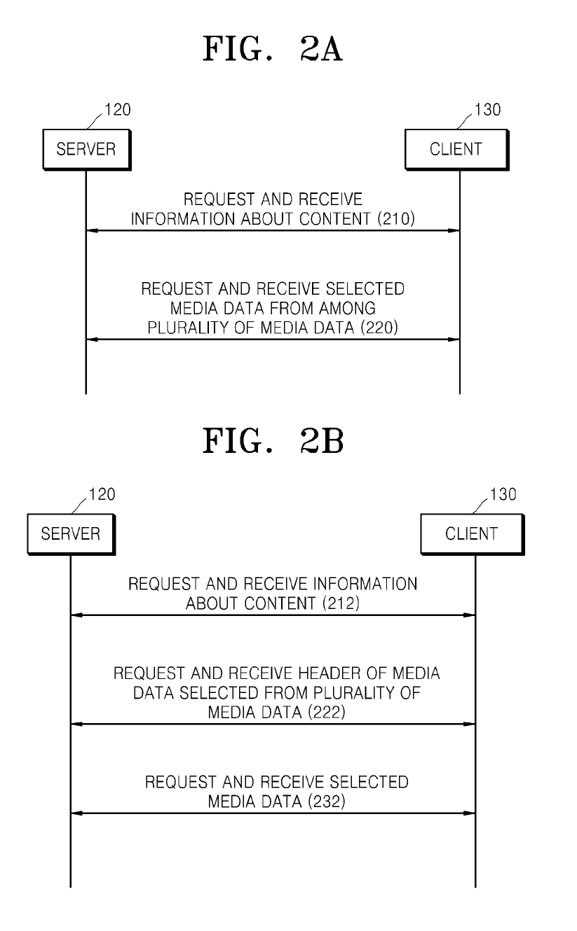

FIG. 2A is a flowchart for describing a streaming method according to an exemplary embodiment.

Referring to FIG. 2A, the client 130 transmits a request to the server 120 to transmit information about predetermined content, in operation 210, which may occur when a user of the client 130 selects the predetermined content from a user interface displayed on a screen of the client 130. The client 130 may respond to the user interface input by transmitting an HTTP request requesting the server 120 to transmit information about predetermined content.

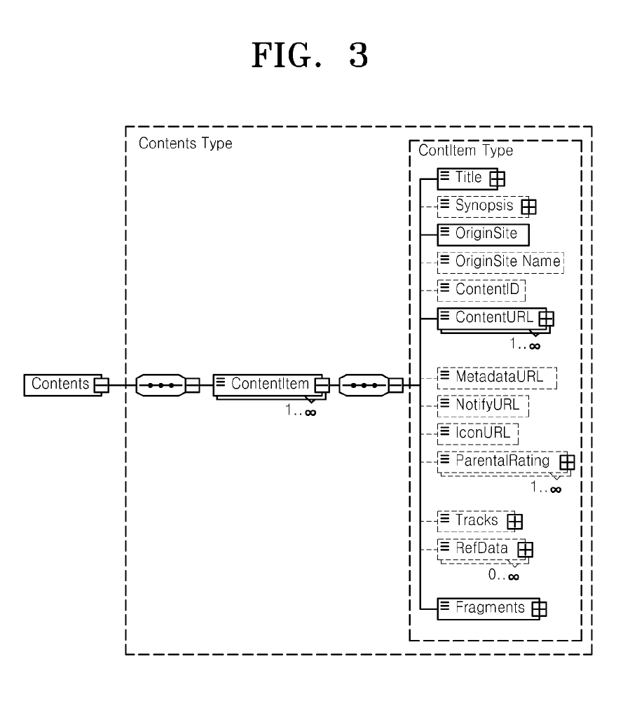

Upon receiving the request from the client 130, the server 120 transmits the information about the predetermined content to the client 130. The server 120 may transmit the information about the predetermined content as an HTTP response to the HTTP request to the client 130. The information about the predetermined content may, for example, be a content access descriptor (CAD) according to an Open IPTV Forum (OIPF) standard. The information about the predetermined content will now be described in detail with reference to FIG. 3.

FIG. 3 is a schema of a file including information about content, according to an exemplary embodiment. The file may be a CAD, and may more concretely be an eXtensible Markup Language (XML) file. Tags and attributes are separately described, but it will be appreciated that an item defined by a tag can be defined by an attribute or an item defined by an attribute can be defined by a tag.

Referring to FIG. 3, the information about the content may include, among other information, “Title”, “Synopsis”, “OriginSite”, and “ContentURL” tags.

Since known approaches to the streaming of media data generate only one media data by encoding one content so as to have only one predetermined quality, the information (specifically, CAD according to OIPF) about content does not include information about a plurality of pieces of media data generated by encoding the content to have different qualities.

However, the information about content, according to an exemplary embodiment, includes information about a plurality of pieces of media data generated by encoding one content to have different qualities, and corresponds to “Tracks”, “RefData”, and “Fragments” tags in FIG. 3.

FIG. 4A illustrates information for defining a plurality of pieces of media data, according to an exemplary embodiment.

Referring to FIG. 4A, a “Tracks” tag is information for classifying a plurality of pieces of media data generated by encoding content to have different qualities. The “Tracks” tag includes an “ID” attribute, a “Type” attribute, and a “Bitrate” attribute assigned to each media data.

The “ID” attribute defines identifiers sequentially given to the plurality of pieces of media data, and the “Type” attribute defines whether media data corresponds to audio data, video data, video/audio data, or subtitle data. When the “Type” attribute is “Packed”, the media data is video/audio data, and when the “Type” attribute is “Video”, the media data is video data. The “Bitrate” attribute defines a bit rate used to encode the media data.

FIG. 4B illustrates information about a header of media data, according to an exemplary embodiment.

Referring to FIG. 4B, a “RefData” tag includes a “Type” attribute and an “ID” attribute. The “Type” attribute defines the media format of the header. For example, when the “Type” attribute is “HEAD-TS”, the header is a header of a transport stream format. The “ID” attribute defines the media data of the header. When the “ID” attribute is “1”, the header is a header of media data having a media data ID of “1”. Also, the “RefData” tag includes information pointing to a header, and a “URL” tag defines a location of a header, i.e., the URL of the header.

The “RefData” tag is a selective element. The “RefData” tag is included in information about content only when the header is separated from the media data and exists as a separate file, and need not necessarily be included in the information about content when the header is combined with the media data.

FIG. 4C illustrates information about at least one segment included in each of a plurality of pieces of media data, according to an exemplary embodiment.

Referring to FIG. 4C, a “Fragment” tag, which is a sub tag of a “Fragments” tag, includes the information about at least one segment included in each of the plurality of pieces of media data.

The “Fragments” tag includes a “NextFragmentsXMLURL” attribute. When following (i.e., subsequent) content is continuously streamed after the streaming of one content is completed (i.e., precedent) as in the case of live streaming, the following content may be seamlessly streamed only when the client 130 is aware of the information about the following content. Accordingly, the “Fragments” tag defines the information about the following content as the “NextFragmentsXMLURL” attribute. URLs of the plurality of pieces of media data pertaining to the following content may be defined in the “NextFragmentsXMLURL” attribute.

The “Fragment” tag includes information about at least one segment of current content. Referring to FIG. 4C, the URL information of “slice1-1.as” indicates the location of the first segment generated by encoding content in a first quality as first media data and is defined by a “URL” tag, and an ID of a corresponding header is defined by a “RefPointer” tag. Also, the start time of the first segment is defined by a “StartTime” attribute, and the duration time of each segment is defined by a “Duration” attribute. The quality level of the first media data is defined by a “BitRate” attribute.

In FIG. 4C, the “Fragments” tag indicates each media data, even if there is only one segment. However, as described above with reference to FIG. 1, it will be appreciated that, when each media data is divided into a plurality of segments, one “Fragments” tag may include information about at least two segments.

Referring back to FIG. 2A, the client 130 requests the server 120 to transmit at least one of the plurality of pieces of media data, in operation 220. The plurality of pieces of media data are generated by encoding one content to have different qualities. The client 130 selects at least one media data encoded to have a quality suitable for a streaming environment from among the plurality of pieces of media data, and requests from the server 120 the selected media data. The client 130 may transmit an HTTP request to the server 120 based on information about the plurality of pieces of media data, which is included in the information about the content.

As described with reference to FIG. 4C, the information about the content may include a “Fragments” tag. Accordingly, the client 130 requests the server 120 to transmit selected media data based on URL information included in the “Fragments” tag.

The server 120 transmits the media data according to the request of the client 130. The server 120 may transmit at least one segment of the requested media data to the client 130. The server 120 may transmit media data requested as an HTTP response pertaining to an HTTP request to the client 130.

FIG. 2B is a flowchart for describing a streaming method according to another exemplary embodiment. FIG. 2B illustrates the streaming method when a header exists as a file separate from the media data.

Referring to FIG. 2B, the client 130 requests the server 120 to transmit information about predetermined content, in operation 212, and the server 120 transmits the information about content. Operation 212 corresponds to operation 210 of FIG. 2A. The information about content including the “RefData” tag described above with reference to FIG. 4B is received.

In operation 222, the client 130 requests the header for the selected media data, based on the information about the content that was received as a result of operation 212. At least one media data suitable for the estimated streaming environment is selected from among the plurality of pieces of media data based on the information about the content received in operation 212, and the header of the selected media data is requested. The header of the selected media data is requested by referring to the “RefData” tag included in the information about the content received in operation 212.

The server 120 transmits the requested header to the client 130. A header file may be transmitted to the client 130, and may be an XML file.

In operation 232, the client 130 requests the server 120 to transmit the selected media data based on the information about the content received in operation 212 and the header received in operation 222. The client 130 requests the server 120 to transmit at least one segment that was generated by dividing the media data based on time, and the server 120 transmits the requested segment or segments to the client 130.

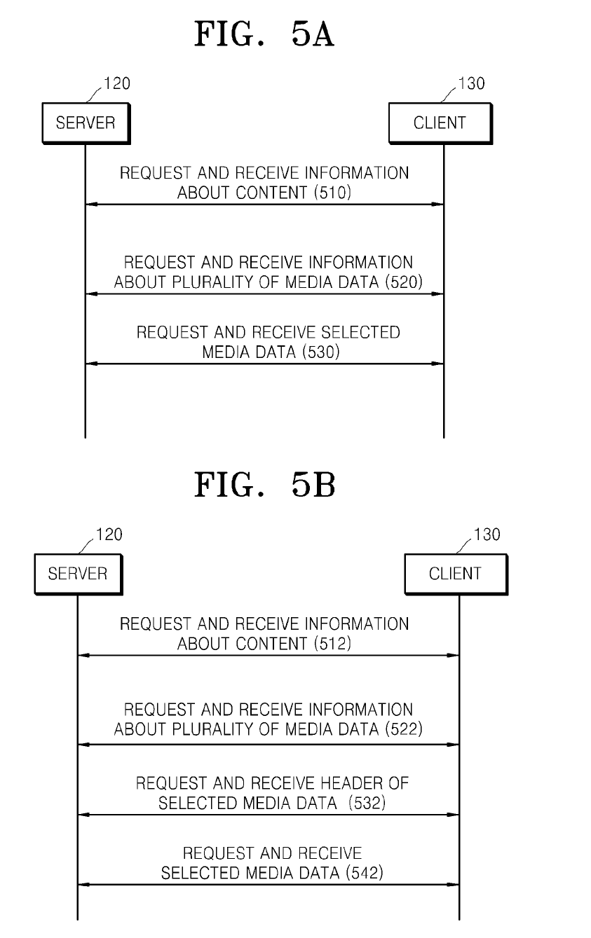

FIG. 5A is a flowchart for describing a streaming method according to another exemplary embodiment.

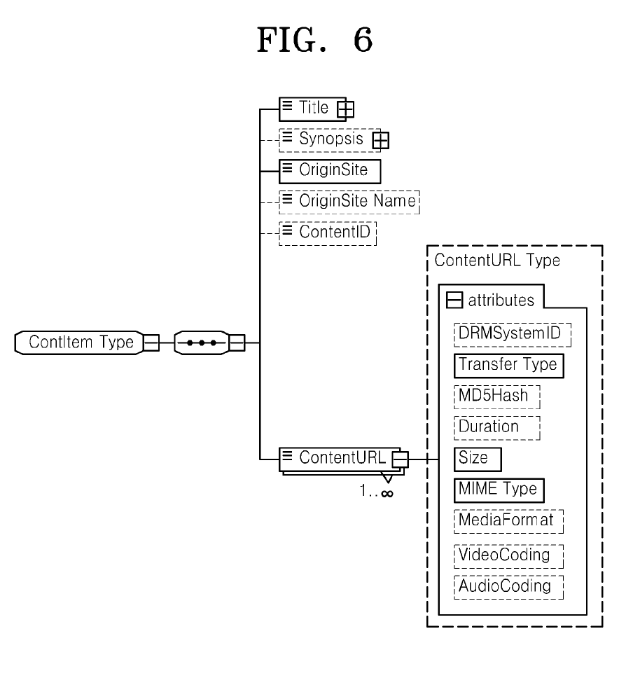

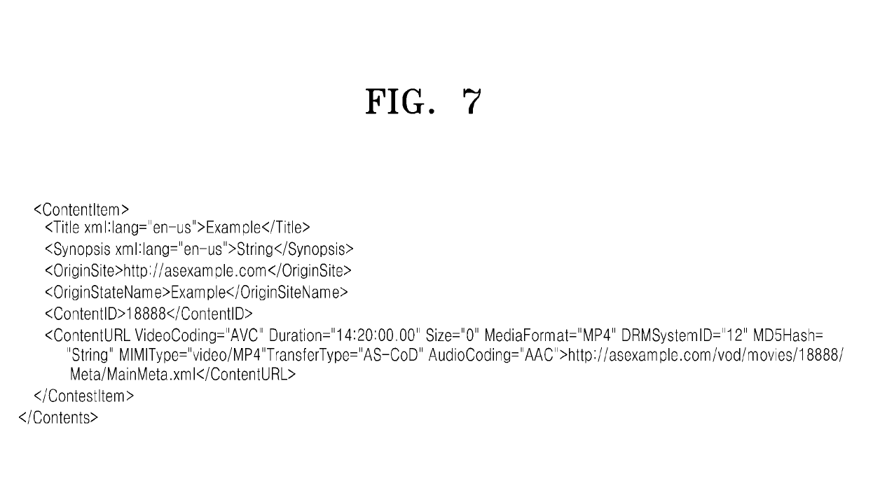

Referring to FIG. 5A, the client 130 requests the server 120 to transmit information about predetermined content, in operation 510, and the server 120 transmits the information about content. The client 130 transmits an HTTP request requesting the server 120 to transmit the information about content, and receives the information about content as an HTTP response to the HTTP request. The information about content may be an XML file. The information about the content received by the client 130 in operation 510 is different from the information about the content received by the client 130 in operation 210 of FIG. 2, and the difference will now be described with reference to FIGS. 6 and 7.

FIG. 6 is a schema of a file including information about content, according to another exemplary embodiment.

Referring to FIG. 6, the information about content according to the current exemplary embodiment may include “Title”, “Synopsis”, “OriginSite”, and “ContentURL” tags like FIG. 3.

However, in FIG. 3, the information about content includes the information about the plurality of pieces of media data by including the “Tracks”, “RefData”, and “Fragments” tags, whereas in FIG. 6, instead of including the information about the plurality of pieces of media data, the information about content defines only a URL of a file (hereinafter, referred to as a media presentation description) including the information about the plurality of pieces of media data. The “ContentURL” tag may define the URL of the media presentation description. That is to say, instances of “ContentItem” in FIG. 3 may include the “Tracks”, “RefData”, and “Fragments” tags, but in FIG. 6 these tags are not included.

Compatibility with various media data formats may therefore be maintained while performing streaming that is adaptive to a streaming environment. This is done by inserting the URL of the media presentation description into the information about content as shown in FIG. 6, without largely changing the schema of the file that contains the information about content, in certain formats that require such a structure.

As shown in FIG. 6, the information about content may include only information related to the streaming method, and may not include the information about the plurality of pieces of media data. In other words, the “ContentURL” tag may include a “MediaFormat” attribute defining a format of media data used during streaming, and a “MIMEType” attribute defining a type of media data.

Specifically, the “ContentURL” tag may include a “TransferType” attribute defining a service to which the streaming of content is related. The “TransferType” attribute may define whether the streaming of content is related to a Content on Delivery (CoD) service, a live service, an adaptive streaming live service, or an adaptive streaming CoD service.

FIG. 7 illustrates information about content according to an exemplary embodiment. FIG. 7 may be a CAD according to the OIPF standard.

Referring to FIG. 7, the information about content generated according to the schema of FIG. 6 may define a URL of a media presentation description in a “ContentURL” tag. http://asexample.com/vod/movies/18888/Meta/MainMeta.xml is the URL of the media presentation description. Also, as described with reference to FIG. 6, the “MediaFormat” attribute, the “MIMEType” attribute, and the “TransferType” attribute may be defined in the “ContentURL” tag.

Referring back to FIG. 5A, in operation 520, the client 130 requests the server 120 for the information about the plurality of pieces of media data, based on the information about the content that was received in operation 510. The client 130 may request a media presentation description to the server 120 through an HTTP request, and may receive the media presentation description as an HTTP response.

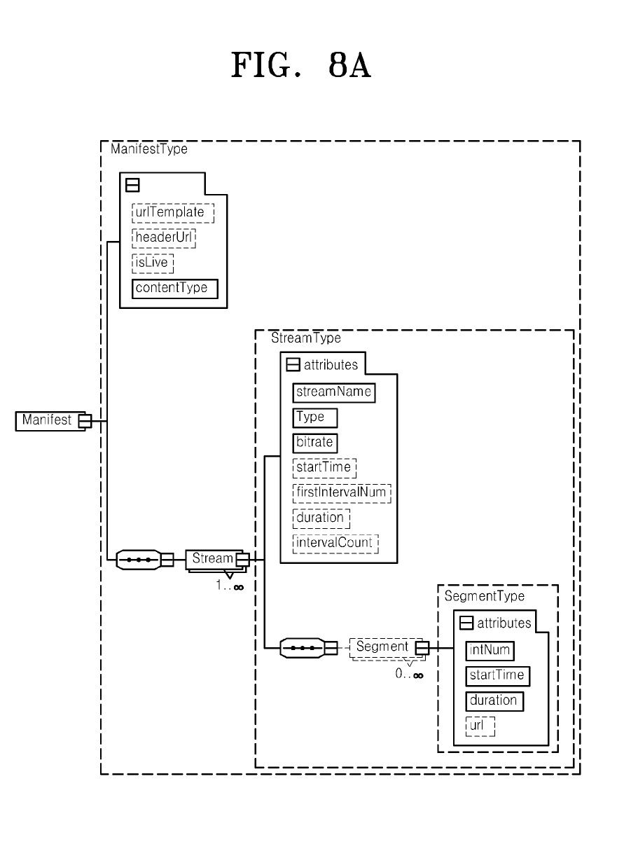

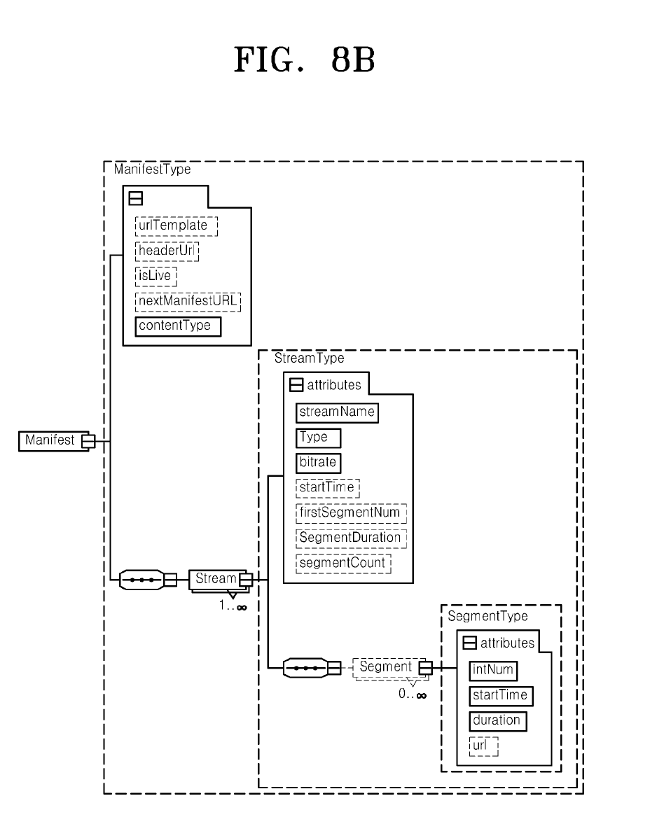

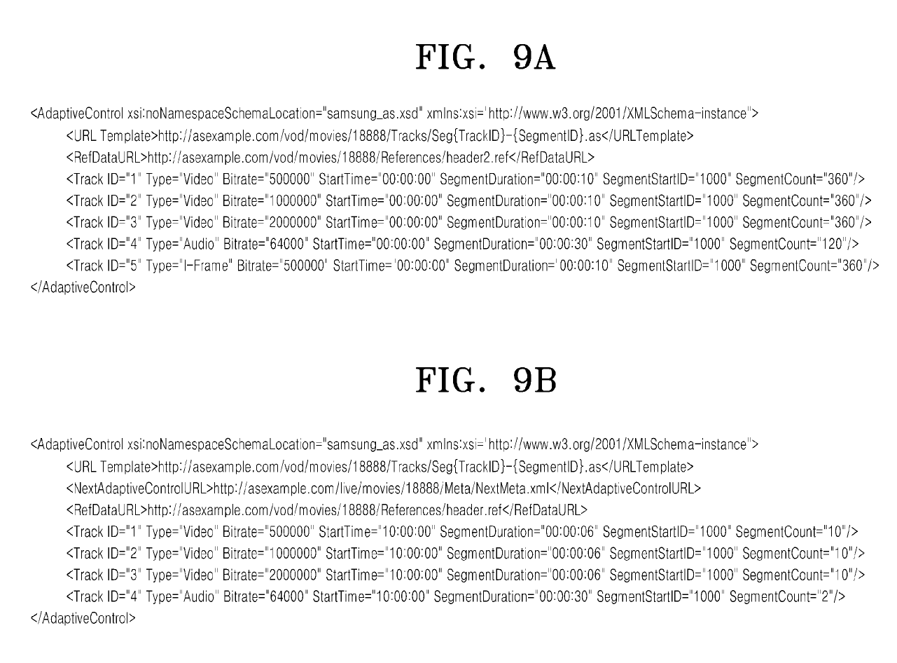

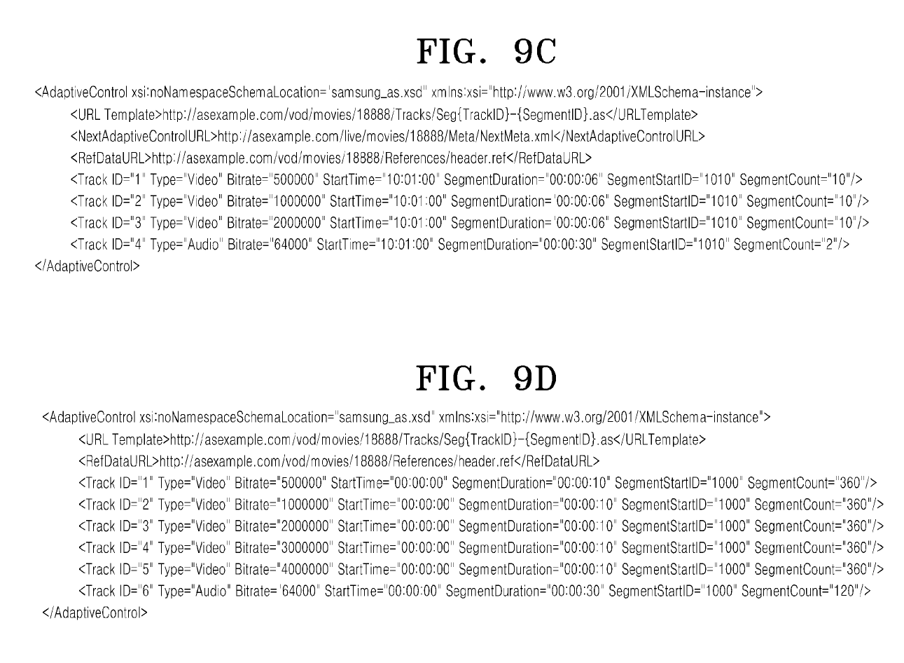

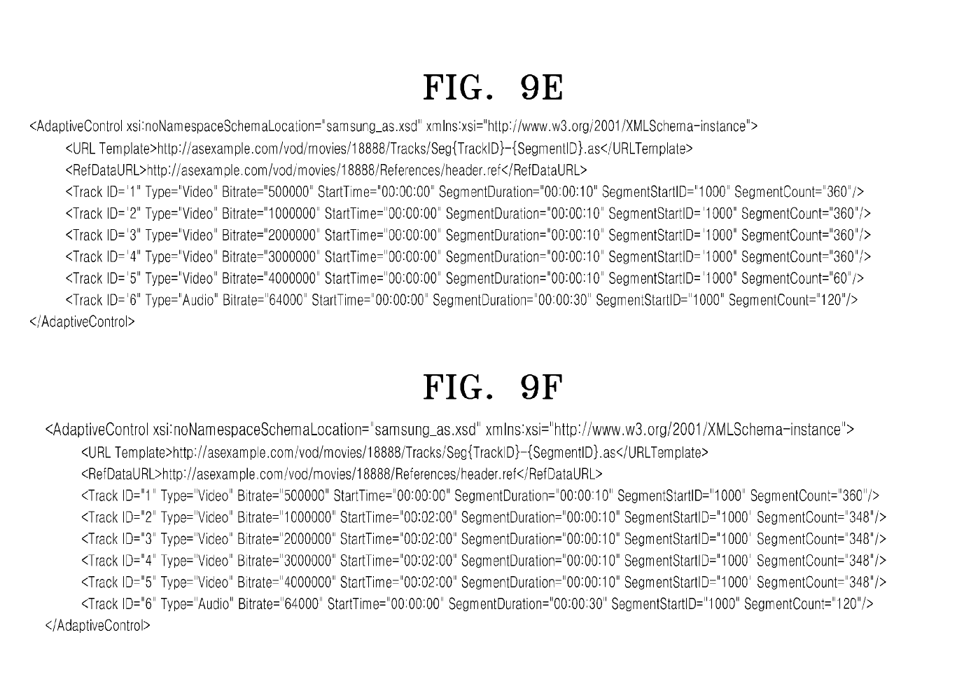

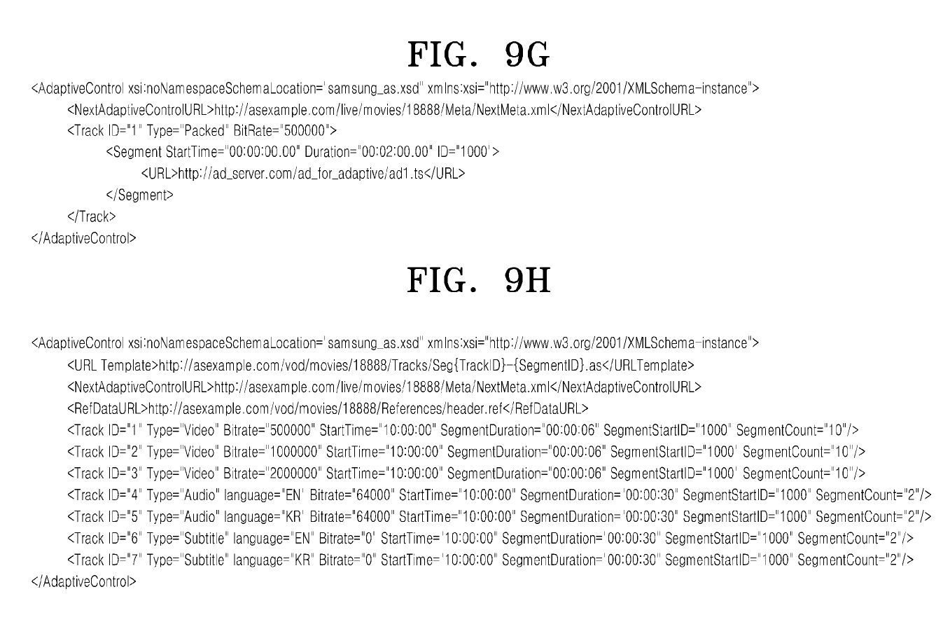

The information about the content received by the client 130 from the server 120 in operation 510 may include the URL of the media presentation description as described with reference to FIGS. 6 and 7, and thus the client 130 requests and receives the media presentation description from the server 120 by referring to the “ContentURL” tag of the information about content. The media presentation description will now be described in detail with reference to FIGS. 8A and 8B, and FIGS. 9A through 9H.

FIGS. 8A and 8B are schemas of a media presentation description according to exemplary embodiments. The media presentation description may comply with the OIPF standard.

Referring to FIG. 8A, the media presentation description according to the current embodiment includes a template tag about URLs of a plurality of pieces of media data, a tag for defining a location of the header, a tag for defining to which service the streaming relates, a tag for defining a container format of media data, and a tag for defining the plurality of pieces of media data.

A “urlTemplate” tag defines a common portion of the URLs of the plurality of pieces of media data. For example, if “http://example.com/vod/movie/18888/Track/{TrackID}/Segments/{SegmentID}” is a URL template, a URL of media data may be defined by respectively substituting an ID of each media data and an ID of at least one segment included in each media data for “TrackID” and “SegmentID”.

A “headerUrl” tag corresponds to the “RefData” tag described with reference to FIG. 4B. In other words, the “headerUrl” tag defines URLs of headers of the plurality of pieces of media data.

An “is Live” tag defines the related streaming service. For example, when the “is Live” tag is defined as “Live”, the streaming is related to a live service, and when the “is Live” tag is defined as “CoD”, the streaming is related to a CoD service.

The “contentType” tag defines the container format of media data used during streaming. The “contentType” tag may indicate whether the container format is an MP4 format or an MPEG2-TS format. The container format is an MP4 format or an MPEG2-TS format herein. However, it will be appreciated that the container format is not limited to that format, and any appropriate container format for transmitting media data may be used in accordance with the needs of the particular situation. For example, the “contentType” tag may indicate an MPEG Media Transport (MMT) standard compliant format.

A “Stream” tag is generated for each media data and defines each media data. In order to define each media data generated by encoding one content to have differing quality levels, the “Stream” tag includes a “streamName” attribute, a “type” attribute, a “bitrate” attribute, a “startTime” attribute, a “firstIntervalNum” attribute, a “duration” attribute, and an “intervalCount” attribute.

The “streamName” attribute defines the name of media data, and may be an ID of media data. The “type” attribute defines the type of media data, i.e., whether the media data is audio data, video data, or audio/video data. When the media data includes only data about an I-frame for a trick play, such information may also be defined in the “type” attribute.

The “Bitrate” attribute defines a bit rate of media data, the “startTime” attribute defines a time stamp for specifying a starting time of media data, and the “firstIntervalNum” attribute defines a number of the initial segment.

The “duration” attribute defines the duration time of the segment included in the media data, and the “intervalConunt” attribute defines the total number segments included in media data.

The “Segment” tag is a sub tag of the “Stream” tag, and, as described above, when the media data includes at least one segment generated by encoding content in a predetermined quality and dividing the encoded content based on time, each of the segments is defined.

The “IntNum” attribute defines the segment number, and the “StartTime” tag defines the starting time of a corresponding segment. The “Duration” tag defines the duration time of the corresponding segment, and the “url” defines the URL of the corresponding segment.

The “Segment” tag is a selective tag, and may optionally be excluded in the media presentation description if the information about at least one segment included in the media data can be inferred from other attributes of the “Stream” tag. In other words, when the content of the “Segment” tag can be inferred from the “startTime”, “firstIntervalNum”, “duration”, and “intervalCount” attributes defined in the “Stream” tag, the “Segment” tag may be omitted from the media presentation description. Also, the “url” attribute of the “Segment” tag might not be required if a predetermined template is defined in the “urlTemplate”, and the URLs of segments are inferred by substituting each ID of the plurality of pieces of media data and an ID of at least one segment included in each media data with the defined predetermined template.

On the other hand, however, the attributes of the “Segment” tag should be separately defined for each segment, if the attributes of the “Segment” tag cannot be inferred from other attributes of the “Stream” tag. It might not be possible to infer the attributes of the “Segment” tag when segment duration varies. When duration times are different, the duration times of segments included in media data cannot be inferred from the attributes of the “Stream” tag, and thus the duration times of the segments may each be set by using the “duration” attribute of the “Segment” tag. When the duration times of the segments are different, the starting times of the continuous segments are also different. For example, when the duration time of the first segment of the first media data is different from a duration time of the second segment of the first media data, the starting time of the second segment and the starting time of a third segment cannot be inferred from the “Stream” tag. Accordingly, the starting time of each segment may be defined by a “startTime” attribute.

The duration times and/or starting times may be defined by using a sub tag of the “Segment” tag, instead of using the “duration” attribute and the “startTime” attribute of the “Segment” tag. For example, a “Url” tag constituting a sub tag of the “Segment” tag may be set, and a duration time may be defined as an attribute of the “Url” tag, such as “<Url=www.example.com/˜/segment.ts, duration=10/>”. According to another exemplary embodiment, the duration time may be defined based on a difference between the duration times of continuous segments. An upper tag may define a default duration time, and the “Url” tag constituting the sub tag may define only the difference between the default duration time and the actual duration time for each segment. As described above, the “Url” tag constituting the sub tag of the “Segment” tag may be defined as “<Url=www.example.com/˜/segment.ts, duration=difference/>”. “Difference” denotes a difference between the default duration time and the actual duration time.

When the default duration time of the corresponding segment is defined to be 10 minutes by using the “Stream” tag or the “Segment” tag, and the “Url” tag constituting the sub tag is defined to be “<Url=www.example.com/˜/segment.ts, duration=2/>”, the duration time of the corresponding segment may be defined to be 10+2=12 minutes.

Referring to FIG. 8B, the media presentation description according to another exemplary embodiment may further include a “nextManifestURL” tag. As described above, when a subsequent or “following” content is streamed continuously after the streaming of the present content is completed, such as in the case of live streaming or advertisement insertion, the client 130 requires foreknowledge of the content to follow so as to stream the following content seamlessly. Accordingly, the URL of the media presentation description of the following content to be streamed after current content may be defined by the “nextManifestURL” tag.

FIGS. 9A through 9H illustrate media presentation descriptions according to exemplary embodiments.

Referring to FIG. 9A, the media presentation description according to an exemplary embodiment includes a “URLTemplate” tag, a “RefDataURL” tag, and a plurality of tags respectively defining a plurality of pieces of media data.

The “URLTemplate” tag and the “RefDataURL” tag of FIG. 9A respectively correspond to the “urlTemplate” tag and the “RefDataURL” tag of FIGS. 8A and 8B.

An “ID” attribute, a “Type” attribute, a “BitRate” attribute, a “StartTime” attribute, a “SegmentDuration” attribute, a “SegmentStartID” attribute, and a “SegmentCount” attribute of FIG. 9A respectively correspond to the “streamName” attribute, the “type” attribute, the “bitrate” attribute, the “startTime” attribute, the “duration” attribute of the “Stream” tag, the “firstIntervalNum” attribute of the “Stream” tag, and the “intervalCount” attribute of FIGS. 8A and 8B.

The media presentation description of FIG. 9A includes information about three pieces of video data generated by encoding content to have different qualities, information about one audio data, and information about media data generated by encoding only I-frames for a trick play.

Referring to FIG. 9B, the media presentation description according to an exemplary embodiment further includes a “NextAdaptiveControlURL” tag. The “NextAdaptiveControlURL” tag corresponds to the “nextManifestURL” tag of FIG. 8B. Accordingly, a URL of a media presentation description of following content to be reproduced after current content may be defined by the “NextAdaptiveControlURL” tag.

FIG. 9C shows a media presentation description of the following content, when the URL of the media presentation description of the following content to be reproduced after the current content is defined by the “NextAdaptiveControlURL” tag of FIG. 9B. Comparing the media presentation descriptions of FIGS. 9B and 9C, the “StartTime” attribute is different from the media presentation description of the current content of FIG. 9B, since the media presentation description of FIG. 9C is for the following content.

FIGS. 9D and 9E illustrate media presentation descriptions for selectively controlling high quality video reproduction that a user wants to perform. FIG. 9D illustrates the media presentation description when a plurality of pieces of media data are generated by encoding one content to have 5 different qualities. Here, the media presentation descriptions of FIGS. 9D and 9E are different in the tag including information about video encoded to have high quality, i.e., a “StartTime” attribute and a “SegmentCount” attribute of media data having an “ID” attribute of “5”.

The server 120 selectively transmits the media presentation description of FIG. 9D or the media presentation description of FIG. 9E according to a user rating pertaining to the client 130. When the user rating of the client 130 is high (for example, when the client 130 is a paid user), the media presentation description of FIG. 9D is transmitted so that high quality video is freely reproduced, and when the user rating of the client 130 is low (for example, when the client 130 is a free user), the media presentation description of FIG. 9E is transmitted so that segments defined by the “SegmentCount” attribute are reproduced based on a time defined by the “StartTime” attribute in high quality video.

FIG. 9F illustrates a media presentation description when an advertisement is inserted into content. Referring to FIG. 9F, the media presentation description may include information about the main content and also advertising content, which have different “StartTime” attributes. The media presentation description may include information about the advertising content, which is reproduced from “00:00:00” to “00:02:00” at a bit rate of “500000”, and information about the main content, which is reproduced from “00:02:00” at bit rates of “1000000”, “2000000”, “3000000”, or “4000000”. The media presentation description of FIG. 9F may be transmitted from the server 120 to the client 130 if the server 120 provides the advertising content to the client 130 by encoding the advertising content to have, e.g., only one bit rate, and provides the main content, which has a different “StartTime” attribute from the advertising content, to the client 130, by encoding the main content in four different bit rates.

FIG. 9G illustrates a media presentation description including information about advertising content, according to an exemplary embodiment. In this example, different servers provide the main content and the advertising content. In other words, when the client 130 receives the main content from the server 120 of FIG. 5A and receives the advertising content from a server other than the server 120, the media presentation description of FIG. 9G may include a URL of the advertising content. As shown in FIG. 9G, the media presentation description may include the URL of the advertising content. Here, too, the advertising content is encoded in just one quality level.

FIG. 9H illustrates a media presentation description including language and subtitle information, according to an exemplary embodiment. Referring to FIG. 9H, the audio data may include information about multiple languages. The media presentation description may include information about the audio data available in multiple languages, wherein an “ID” attribute is “4” or “5.” Here, where the “ID” attribute is “6” or “7” it indicates information about subtitles in different languages.

Since not only the audio data, but also the subtitle data, may be divided into a plurality of segments according to time, the audio data and the subtitle data may be changed to audio data and a subtitle data of another language during streaming.

Referring back to FIG. 5A, the client 130 requests the server 120 to transmit at least one of the plurality of pieces of media data, in operation 530. The client 130 selects at least one media data that is encoded to have a quality suitable for the estimated streaming environment by referring to the information about the plurality of pieces of media data, and requests the server 120 for the selected media data. The client 130 may transmit an HTTP request requesting the server 120 to transmit the predetermined media data. The server 120 transmits the media data according to the request of the client 130. Alternatively, the server 120 may transmit at least one segment generated by encoding content to have a predetermined quality and dividing the encoded content based on time, to the client 130. The server 120 may transmit the requested media data to the client 130 as an HTTP response to the HTTP request.

FIG. 5B is a flowchart for describing a streaming method according to another exemplary embodiment.

Referring to FIG. 5B, the client 130 requests the server 120 to transmit information about predetermined content, in operation 512, and receives the information about predetermined content from the server 120. The client 130 may transit an HTTP request requesting the server 120 to transmit the information about predetermined content, and receive the information about predetermined content as an HTTP response to the HTTP request. The information about predetermined content may be included in an XML file.

In operation 522, the client 130 requests the server 120 to transmit information about a plurality of pieces of media data based on the information about predetermined content that was received in operation 512. The client 130 may request the server 120 for a media presentation description through the HTTP request, and receive the media presentation description as the HTTP response.

In operation 532, the client 130 requests a header of media data selected based on the information, about the plurality of pieces of media data, received in operation 522. At least one media data that is suitable for the estimated streaming environment is selected, from among the plurality of pieces of media data, based on the information about the plurality of pieces of media data received in operation 522, and a header of the selected media data is requested. The header of the selected at least one media data is requested by referring to the information about the plurality of pieces of media data received in operation 522. The server 120 transmits a file containing the header of the selected at least one media data to the client 130 in response to the client's request.

In operation 542, the client 130 requests the server 120 to transmit selected media data based on the information about the plurality of pieces of media data received in operation 522, and the header received in operation 532. The client 130 requests the server 120 to transmit at least one segment generated by encoding content to have a predetermined quality and dividing the encoded content based on time, and the server 120 transmits the requested at least one segment to the client 130.

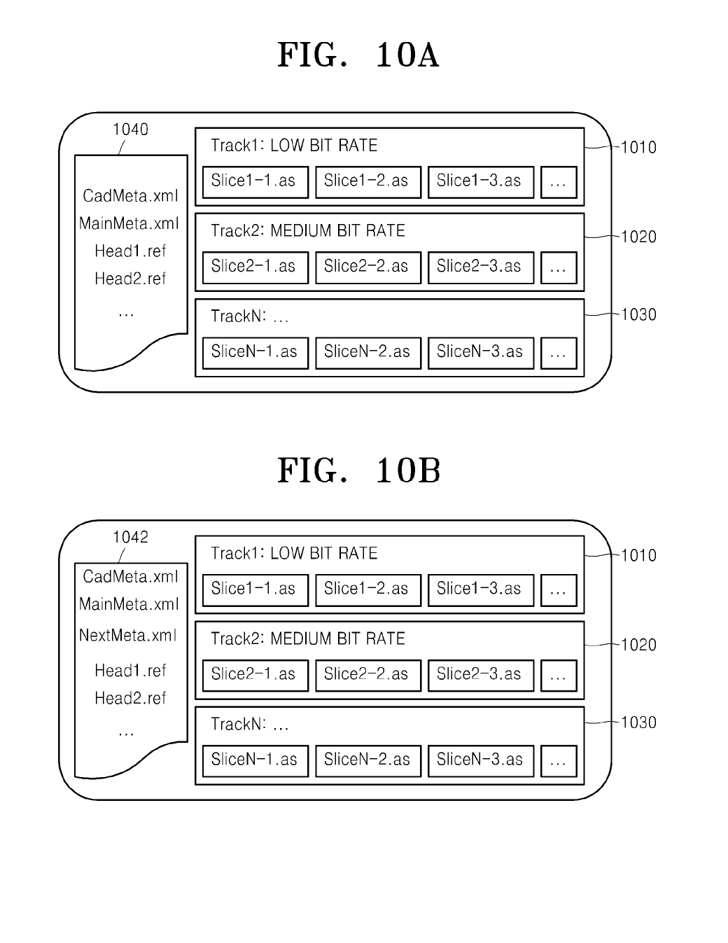

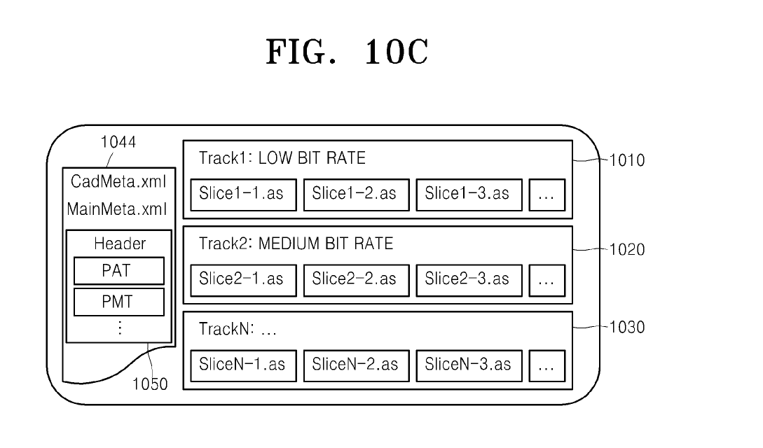

FIGS. 10A through 10C each illustrate a plurality of pieces of media data according to exemplary embodiments. FIGS. 10A through 10C each illustrate the plurality of pieces of media data, included in the server 120, and used in connection with perform the streaming methods according to FIGS. 5A and 5B.

Referring to FIG. 10A, the server 120 may include a plurality of pieces of media data 1010 through 1030 generated by encoding one input content to have a plurality of different qualities, for use in streaming adaptive to a streaming environment. “Track1” through “TrackN” denote the plurality of pieces of media data 1010 through 1030. Also, each of the plurality of pieces of media data 1010 through 1030 may include at least one segment generated by dividing each of the plurality of pieces of media data 1010 through 1030 based on time. “Slice1-1.as”, “Slice1-2.as”, “Slice1-3.as”, “Slice2-1.as”, “Slice2-2.as”, “Slice2-3.as”, “SliceN-1.as”, “SliceN-2.as”, and “SliceN-3.as” denote such segments.

The server 120 may include information 1040 required for the client 130 to access the plurality of pieces of media data 1010 through 1030. The server 120 may include a “CadMeta.xml” file as information about the content, a “MainMeta.xml” file as information about the plurality of pieces of media data 1010 through 1030, and a “Head1.ref” file, a “Head2.ref” file, etc. as header files for the plurality of pieces of media data 1010 through 1030. Here, the “Head1.ref” file may be a header file of the “Track1”, and the “Head2.ref” file may be a header file of the “Track2”.

The “CadMeta.xml” file may be a CAD file according to the OIPF standard, and the “MainMeta.xml” file may be the media presentation description described above. Also, the “Head1.ref” and “Head2.ref” files can be optional elements, and may be omitted in implementations in which headers are included in the plurality of pieces of media data 1010 through 1030.

Referring to FIG. 10B, information 1042 required for the client 130 to access the plurality of pieces of media data 1010 through 1030 may further include a “NextMeta.xml” file. As described above, the “NextMeta.xml” file may be a media presentation description of a following or subsequent content to be reproduced after current content. As described above, the media presentation description of the current content, i.e., the “MainMeta.xml” file, includes the URL of the media presentation description of the following content, and thus the client 130 may access the “NextMeta.xml” file based on the “MainMeta.xml” file.

Referring to FIG. 10C, the header files of the plurality of pieces of media data 1010 through 1030 may all exist within one header file 1050. Instead of existing for each of the plurality of pieces of media data 1010 through 1030, the header files may exist as one header file 1050 and may be included in information 1044 required to access the plurality of pieces of media data 1010 through 1030.

For example, when each of the plurality of pieces of media data 1010 through 1030 corresponds to an elementary stream, for example, an elementary stream according to MPEG-2, the header files of the plurality of pieces of media data 1010 through 1030 may be implemented as a header file 1050 which includes a program association table (PAT) and a program map table (PMT). The PAT and/or the PMT are separated from the plurality of pieces of media data 1010 through 1030 to prepare the header file 1050, and the media presentation description may include information pointing to the header file 1050. The information pointing to the header file 1050 may be URL information indicating the header file 1050, or may be information for specifying a packet that includes the header file 1050 in an MPEG-2 transport stream (TS). Since the header file 1050 includes the PAT and/or the PMT, it constitutes an initialization segment, and may be transmitted to the client 130 before the segments that include the payload data, so as to initiate the reproduction of the plurality of pieces of media data 1010 through 1030.

Referring back to operation 532 of FIG. 5B, the client 130 may obtain the information pointing to the header file 1050 by referring to the media presentation description, and may request the header file 1050 based on the information pointing the header file 1050. After requesting and receiving the header file 1050 (based on the information pointing to the header file 1050), at least one of the plurality of pieces of media data 1010 through 1030 is selected based on at least one of the PAT and the PMT included in the header file 1050, and the selection is requested from the server 120. The PAT and the PMT may be separated as in the header file 1050, or may be included in the plurality of pieces of media data 1010 through 1030, but either way it may include an entire list of elementary streams included in the plurality of pieces of media data 1010 through 1030 regardless of locations of the PAT and the PMT.

According to the MPEG-2 format, packet IDs (PIDs) defined in the PAT and the PMT are different according to elementary streams. Accordingly, PIDs assigned to each of the plurality of pieces of media data 1010 through 1030 may be different. Alternatively, according to another exemplary embodiment, since the plurality of pieces of media data 1010 through 1030 generated by encoding one input content so as to have different quality levels are elementary streams of the same content, the same PID may be set.

When the plurality of pieces of media data 1010 through 1030 correspond to a plurality of elementary streams according to the MPEG-2 format, each of a plurality of segments included in the plurality of pieces of media data 1010 through 1030 may include at least one continuous packetized elementary stream (PES). However, one PES is included in one segment. In other words, one PES is not divided into two different segments.

Since a plurality of pieces of media data are generated by encoding one input content to have different qualities, presentation time stamps (PTSs) and/or decoding time stamps (DTSs) included in PESs of the plurality of pieces of media data may be aligned according to reproduction times. In other words, if an initial PES of a first media data and an initial PES of a second media data relate to content reproduced at the same time, a PTS and/or a DTS may be equally set.

Further, when the second media data is reproduced while reproducing the first media data by changing media data according to the streaming environment, the PTSs and/or the DTSs may be kept continuously aligned so that the first and second media data are both continuously reproduced. In other words, when the second media data is reproduced while reproducing the first media data by changing media data, the PTS and/or the DTS of the last PES before the changing and the PTS and/or the DTS of the first PES after the changing may be continuously set.

The PTS and/or the DTS define a time stamp of video data. Accordingly, time stamps of the plurality of pieces of media data pertaining to video data are aligned according to the reproduction times of the plurality of pieces of media data as described above. Such alignment of the time stamps based on the reproduction times may be equally applied to audio data. In other words, like the time stamps of the plurality of pieces of media data pertaining to the video data, time stamps of the pieces of media data pertaining to the audio data may also be aligned according to the reproduction times for adaptive streaming.

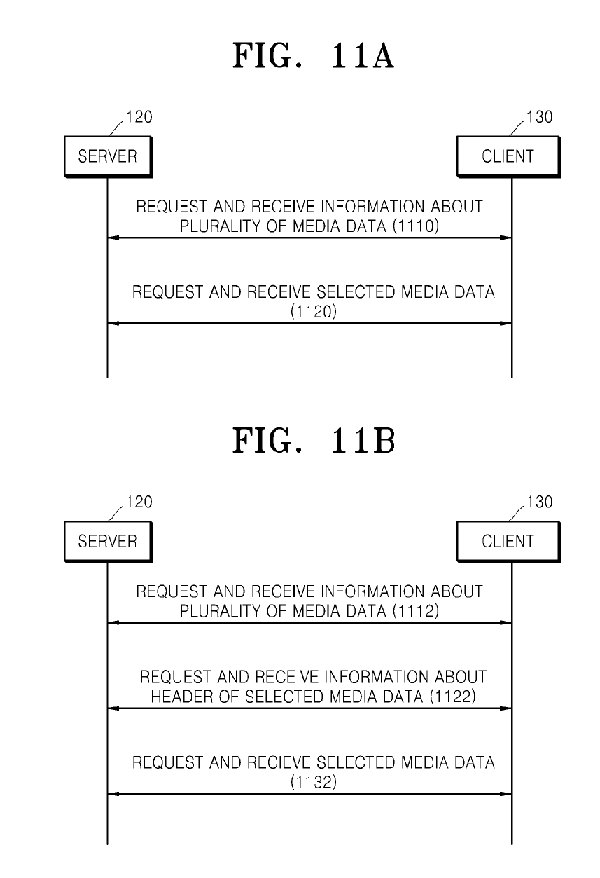

FIG. 11A is a flowchart for describing a streaming method according to another exemplary embodiment.

Referring to FIG. 11A, the client 130 requests information about a plurality of pieces of media data to the server 120, in operation 1110. The client 130 may request the media presentation description from the server 120 via an HTTP request, and may receive the media presentation description as an HTTP response. The client 130 requests from the server 120 and receives the information about the plurality of pieces of media data generated by encoding one content to have a plurality of different qualities, so as to perform streaming that is adaptive to a streaming environment. The streaming method of FIG. 11A is different from the streaming method of FIG. 5A for at least the reason that the information about the plurality of pieces of media data is requested and received without requesting and receiving information about content.

In operation 1120, the client 130 requests the server 120 to transmit at least one of the plurality of pieces of media data. The client 130 selects and requests at least one media data that is encoded to have a quality suitable for the estimated streaming environment by referring to the information about the plurality of pieces of media data, and receives the requested media data from the server 120.

FIG. 11B is a flowchart for describing a streaming method according to another exemplary embodiment.

Referring to FIG. 11B, the client 130 requests the server 120 to transmit information about a plurality of pieces of media data and receives the information in response to the request, in operation 1112. The client 130 may request from the server 120 a media presentation description through an HTTP request, and receive the media presentation description as an HTTP response.

In operation 1122, the client 130 requests the header of the selected media data based on the information about the plurality of pieces of media data received in operation 1112. The client 130 requests the header of media data selected according to an estimated streaming environment by referring to the information, about the plurality of pieces of media data, received in operation 1112. In response to the request, the server 120 transmits a file including the header of the selected media data to the client 130.

In operation 1132, the client 130 requests the server 120 to transmit the media data, selected based on the information about the plurality of pieces of media data received in operation 1112, and on the header received in operation 1122. The client 130 requests the server 120 to transmit at least one segment generated by encoding content in a predetermined quality and dividing the encoded content based on time, and the server 120 transmits the requested segment or segments to the client 130.

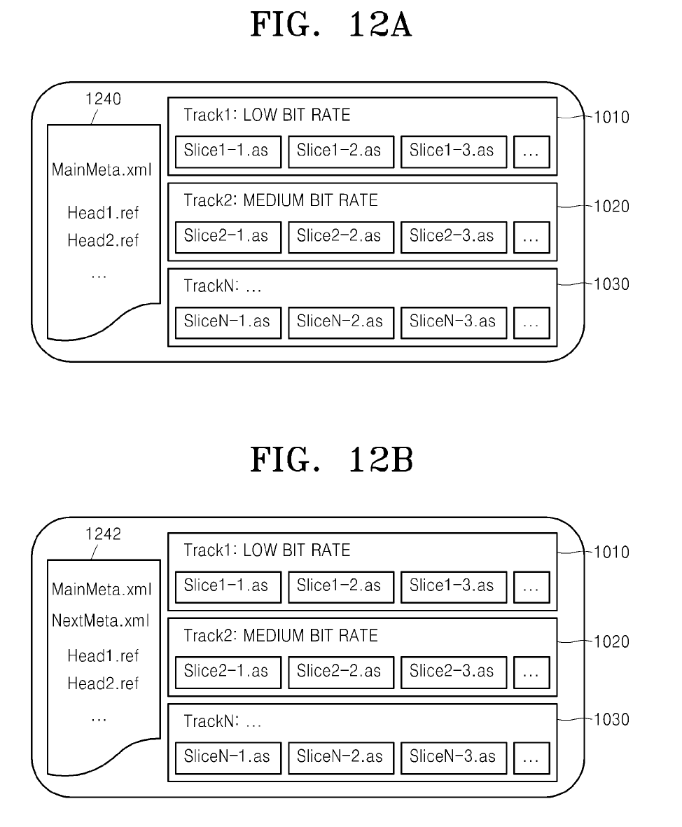

FIGS. 12A and 12C each illustrate a plurality of pieces of media data according to other exemplary embodiments. FIGS. 12A and 12B each illustrate the plurality of pieces of media data included in the server 120, which are used to perform the streaming methods of FIGS. 11A and 11B.

Referring to FIG. 12A, the server 120 may include the plurality of pieces of media data 1010 through 1030, generated by encoding one input content to have the plurality of different qualities for streaming that is adaptive to a streaming environment, as shown in FIG. 10A.

Here, the plurality of pieces of media data 1010 through 1030 of FIG. 12A are different from the plurality of pieces of media data 1010 through 1030 of FIG. 10A at least in respect to the information 1240 required for the client 130 to access the plurality of pieces of media data 1010 through 1030; the server 120 only includes information about the plurality of pieces of media data 1010 through 1030 and not information about content, unlike the embodiment of FIG. 10A. Here, the client 130 may receive the information about content from another entity instead of the server 120, and access the plurality of pieces of media data 1010 through 1030 included in the server 120, based on the received information about the content.

Referring to FIG. 12B, information 1242 required for the client 130 to access the plurality of pieces of media data 1010 through 1030 may be prepared by further including a “NextMeta.xml” file with the information 1240 of FIG. 12A.

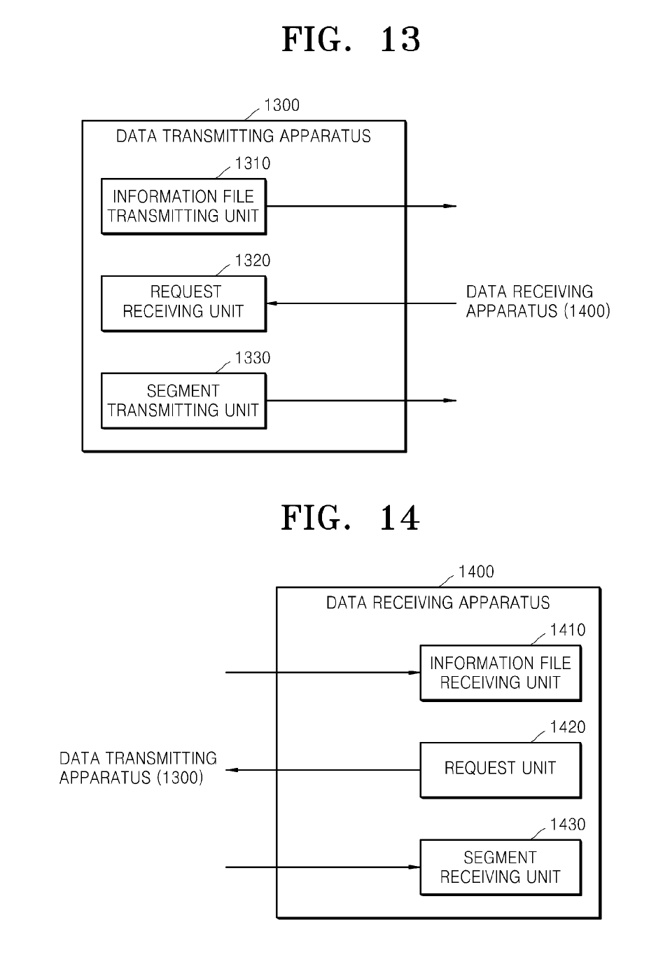

FIG. 13 is a block diagram of a data transmitting apparatus 1300 according to an exemplary embodiment.

The data transmitting apparatus 1300 according to the exemplary embodiment may include an information file transmitting unit 1310, a request receiving unit 1320, and a segment transmitting unit 1330.

The information file transmitting unit 1310 generates an information file pertaining to the media data, and transmits the information file to a data receiving apparatus 1400. The information file may be a CAD or an MPD according to the OIPF standard. The information file may include all the pieces of information pertaining to the plurality of pieces of media data to be changed and reproduced by the data receiving apparatus 1400.

The plurality of pieces of media data to be changed and reproduced by the data receiving apparatus 1400 may be divided into two types.

First, as described above regarding FIGS. 1 through 12B, the data transmitting apparatus 1300 may generate a plurality of pieces of media data by encoding predetermined content to have different qualities. For example, the data transmitting apparatus 1300 may generate the plurality of pieces of media data having the same content and different qualities by encoding content by various encoding methods (e.g., MPEG2 and MPEG4) or encoding parameters.

Second, the data transmitting apparatus 1300 may generate a plurality of pieces of media data by separately encoding different correlated contents. For example, the data transmitting apparatus 1300 may generate first media data by encoding left-viewpoint image data and generate second media data by encoding right-viewpoint image data, or may generate first media data by encoding image data of a base layer and generate second media data by encoding image data of an enhancement layer. In this case, the plurality of pieces of media data may have different contents.

In the instance in which the data receiving apparatus 1400 reproduces one media data and then reproduces another media data included in one group, the media data may be changed by units of segments. The segments are obtained by temporally dividing the media data, and the data receiving apparatus 1400 may request the segments pertaining to the media data to be reproduced, by using information (e.g., an address to receive the segments) pertaining to the segments which is included in the information file.

The information file may include reproduction rating information pertaining to each of the segments. A reproduction rating indicates a condition for reproduction of a corresponding segment, and, for example, the reproduction rating may indicate an age of a user who may reproduce or view the segment.

According to a known approach, it is uneconomical for a server to generate and provide a plurality of pieces of media data with matched, respective reproduction ratings. However, according to the exemplary embodiments, the reproduction rating may be set for each of the segments so that the data receiving apparatus 1400 may appropriately process the segments according to the reproduction ratings, and it is therefore unnecessary for the server to generate the plurality of pieces of media data that match the reproduction ratings, respectively.

The reproduction rating information may include location information pertaining to a period having a predetermined reproduction rating, and a reproduction rating of the period.

The location information pertaining to the period may be displayed by using identification information pertaining to first and last segments in the period or by using a start time and an end time of the period. For example, in a case where a plurality of pieces of media data are aligned, it may be more convenient to display the location information pertaining to the period by using identification information pertaining to a segment. However, in a case where a plurality of pieces of media data are not aligned, it may be more convenient to display the location information pertaining to the period by using the time information pertaining to the period.

In the present description, when a plurality of pieces of media data have the same structure, the plurality of pieces of media data may be referred to as being aligned. In a case in which the plurality of pieces of media data are aligned, the number of segments, the positions of the segments, and the identification number of the segments forming the plurality of pieces of media data may be the same. That is, when the first media data and the second media data are aligned, the 10^{th} segment in the first media data corresponds to the 10^{th} segment in the second media data. Thus, in the scenario in which a user watches a 9^{th} segment in the first media data and then watches the second media data included in one group, the data receiving apparatus 1400 may receive and reproduce the 10^{th} segment in the second media data.

Thus, in the situation in which the plurality of pieces of media data are aligned, segments having the same identification information in the plurality of pieces of media data of one group are placed in the same locations, so that it is efficient to deliver the location information pertaining to the period by using the identification information pertaining to the segments included in the period.

However, in a case where the plurality of pieces of media data are not aligned, segments having the same identification information in the plurality of pieces of media data of one group will be in different locations, so that it is difficult to deliver the location information pertaining to the period by using the identification information pertaining to the segments. Thus, when the plurality of pieces of media data are not aligned, it is convenient to indicate a start location and an end location of the period by using time information (e.g., PTS, DTS, global time, etc.).

The start location of the period is indicated either by using identification information of the first segment in the period, or by using the start location of the period as indicated by using start-time information of the period. A start of the period may be a random access point.

Rating information may include rating information that pertains to all periods in the media data, but could include rating information with respect only to a period having a predetermined rating. For example, the rating information may include information pertaining to a period to be reproduced or viewed by only a user over a predetermined age.

The rating information may be commonly applied to a plurality of pieces of media data to be changed and reproduced by the data receiving apparatus 1400, or may be applied to only some of a plurality of pieces of media data. In the former case, the rating information includes only an identifier of a group that includes the plurality of pieces, and in the latter case, the rating information includes identification information pertaining to the particular media data to which corresponding rating information is to be applied.

In the case where a plurality of pieces of media data of one group are generated by encoding the same content to have different qualities, if first media data and second media data are included in the one group, data at a predetermined location in the first media data and data at a predetermined location in the second media data are about the same content. Thus, the data at the predetermined location in the first media data and the data at the predetermined location in the second media data generally have the same reproduction rating, and, in this case, the rating information may be commonly applied to the plurality of pieces of media data of the one group. Accordingly, to convey the rating information, it is sufficient to include only the identifier of the group to which the rating information is to be applied.

On the other hand, in a case in which a plurality of pieces of media data of one group are generated by separately encoding different, correlated contents (e.g., a plurality of pieces of media data are generated by separately encoding left-viewpoint image data and right-viewpoint image data). Although the first media data and the second media data are included in the one group, it is not guaranteed that data at a predetermined location in the first media data and data at a predetermined location in the second media data are pertaining to the same content. Thus, different reproduction ratings may be applied to a segment included in the predetermined location in the first media data and a segment included in the predetermined location in the second media data. Therefore, it is preferable that the rating information includes identification information pertaining to the media data to which the rating information is to be applied.

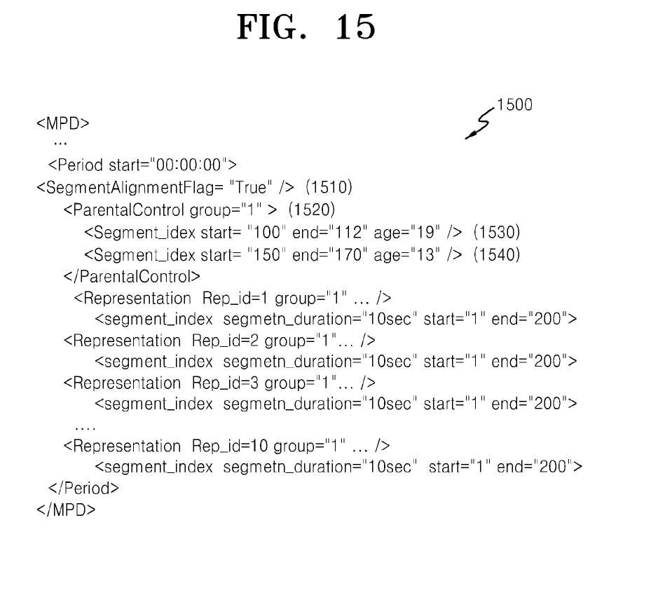

Which tag in the information file includes the rating information may vary according to embodiments. Examples in which the rating information is provided in the information file will be described below with reference to FIGS. 15 through 19.

The request receiving unit 1320 receives a request for the transmission of a segment from the data receiving apparatus 1400. Based on the information file that corresponds to the media data, the data receiving apparatus 1400 may request the transmission of a desired segment.

In response to the request, the segment transmitting unit 1330 transmits at least one segment to the data receiving apparatus 1400.

FIG. 14 is a block diagram of the data receiving apparatus 1400, according to an exemplary embodiment.

The data receiving apparatus 1400 includes an information file receiving unit 1410, a request unit 1420, and a segment receiving unit 1430.

The information file receiving unit 1410 receives an information file pertaining to a plurality of pieces of media data included in one group. As described above, the plurality of pieces of media data included in one group indicates the group of a plurality of pieces of media data to be changed and reproduced by the data receiving apparatus 1400 by encoding one input content to have different quality levels or by encoding a plurality of pieces having related content.

The information file for a plurality of pieces of media data includes reproduction rating information pertaining to each of the segments forming the plurality of pieces of media data.

The request unit 1420 requests a desired segment based on the information file pertaining to a plurality of pieces of media data. The data receiving apparatus 1400 may previously set a reproduction rating of a segment to receive, and the request unit 1420 may thus be set to request only segments that satisfy the set reproduction rating.

The segment receiving unit 1430 receives from the data transmitting apparatus 1300 only segments that satisfy the reproduction rating set by the data receiving apparatus 1400. Alternatively, the receiving unit 1430 receives all segments and then discards or re-processes segments that do not satisfy the set reproduction rating. For example, the data transmitting apparatus 1300 may skip the segments that do not satisfy the set reproduction rating and then may reproduce the media data, or may apply a mosaic pattern to the segments not satisfying the set reproduction rating and then output the media data.

FIG. 15 illustrates an information file 1500 pertaining to media data, according to an exemplary embodiment.

The information file 1500 includes reproduction rating information pertaining to segments.

A ‘SegmentAligmnentFlag’ tag 1510 indicates whether a plurality of pieces of media data included in one group are aligned. As described above, when a plurality of pieces of media data are aligned, the plurality of pieces of media data have the same structure. If the ‘SegmentAligmnentFlag’ tag 1510 has a value of ‘True’, it means that the plurality of pieces of media data are aligned. Otherwise, if the ‘SegmentAligmnentFlag’ tag 1510 has a value of ‘False’, it means that the plurality of pieces of media data are not aligned. Referring to FIG. 15, the ‘SegmentAligmnentFlag’ tag 1510 has a value of ‘True’, so that the plurality of pieces of media data included in the one group are aligned.

A ‘parental control’ tag 1520 indicates media data to which reproduction rating information is to be applied. The ‘parental control’ tag 1520 has a ‘group’ attribute that identifies a group to which the reproduction rating information applies. Referring to FIG. 15, the reproduction rating information relates to the plurality of pieces of media data included in ‘group=1’.

The ‘segment_index’ tags 1530 and 1540 indicate reproduction rating information for each of a plurality of segments. The ‘segment_index’ tags 1530 and 1540 include a ‘start’ attribute, an ‘end’ attribute, and an ‘age’ attribute. The ‘start’ attribute indicates the start location of the period having a predetermined rating, the ‘end’ attribute indicates the end location of the period, and the ‘age’ attribute indicates the reproduction rating of the period. Referring to FIG. 15, the location of the period is indicated by identifier for the first segment in the period, and an identifier for the last segment in the period. Thus, it is possible to ensure that only a user equal to or greater than an age of 19 may reproduce and/or view segments having identification numbers of ‘100 through 112’, and only a user equal to or greater than an age of 13 may reproduce segments having identification numbers of ‘150 through 170’.

Referring to a ‘Representation’ tag, it is possible to see that all pieces of media data are made up of 200 segments, and that each segment has a duration time of 10 seconds. That is, the representations are in this example aligned.

The data receiving apparatus 1400 receives the information file 1500, and then either selectively receives segments according to the reproduction setting or, alternatively, receives all segments and re-processes them after receipt. For example, according to the reproduction setting, if the segments are to be reproduced by a user equal to or less than an age of 13, the data receiving apparatus 1400 may either not receive the segments having identification numbers of ‘100 through 112’ and the segments having identification numbers of ‘150 through 170’ (i.e., the segments will not be sent or the segments can be refused), or may receive and then discard them, or may receive and then re-process them so as to be reproduced in an acceptable manner for the user equal to or less than the age of 13.

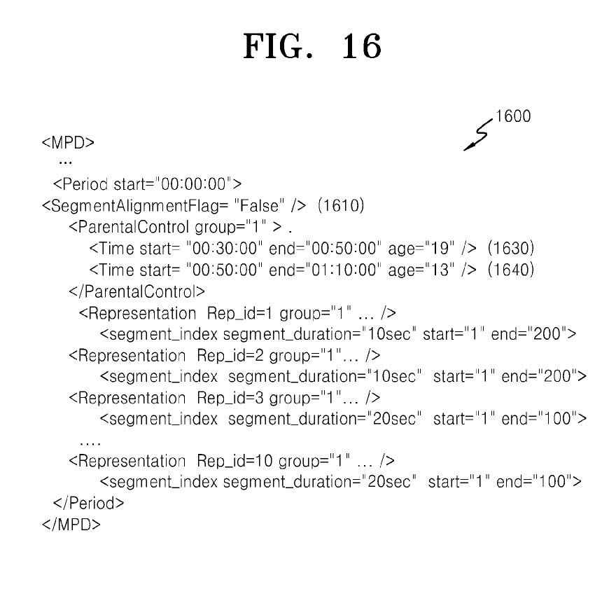

FIG. 16 illustrates an information file 1600 pertaining to media data, according to another exemplary embodiment.

Referring to a ‘SegmentAligmnentFlag’ tag 1610, in FIG. 16, the plurality of pieces of media data included in the group are not aligned. In this case, where the plurality of pieces of media data are not aligned, it may be difficult to define periods to which the same reproduction rating is applied, by using identification numbers. Therefore, the location of the period is indicated by a start and an end time of the period.

Referring to the ‘Representation’ tag, two pieces of media data having identification numbers of 1 and 2 are made of 200 segments, each of which has a duration time of 10 seconds. On the other hand, two pieces of media data having identification numbers of 3 and 4 are formed of 100 segments, each of which has a duration time of 20 seconds. That is, the plurality of pieces of media data are not aligned.

The ‘segment_index’ tags 1630 and 1640 include a ‘start’ attribute, an ‘end’ attribute, and an ‘age’ attribute. Here, the ‘start’ attribute and the ‘end’ attribute indicate the location of the period by using a start time and an end time of the period. In FIG. 16, pertaining to the point in time at which the first segment in the period is reproduced, the data corresponding to the reproduction time of ‘00:30:00-00:50:00’ may permissibly be reproduced only by users equal to or greater than the age of 19, and the data corresponding to the reproduction time of ‘00:50:00-01:10:00’ may be reproduced only by users equal to or greater than the age of 13. In FIG. 16, the location of the period is defined by using a reproduction time format indicated by hours, minutes, and second, but in another embodiment, it is possible to use a reproduction time format of PTS, DTS, or the like.

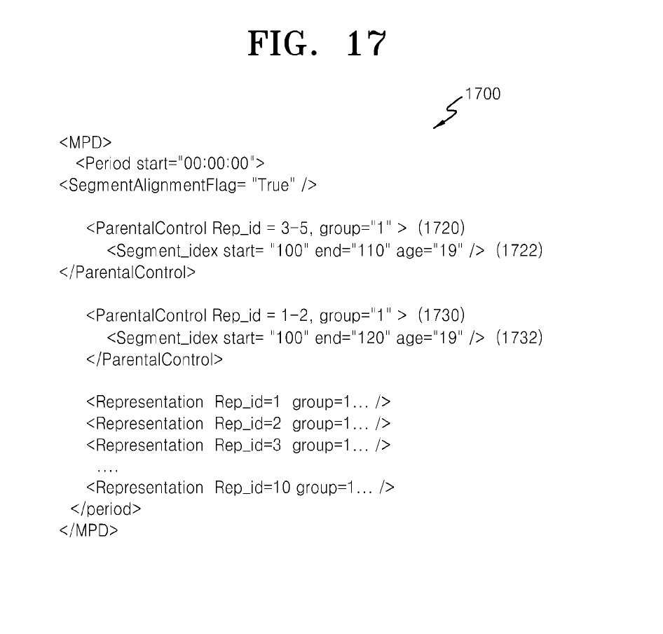

FIG. 17 illustrates an information file 1700 pertaining to media data, according to another exemplary embodiment.

In FIG. 17, ‘parental control’ tags 1720 and 1730 include a ‘Rep_id’ attribute and a ‘group’ attribute. The ‘Rep_id’ attribute indicates the identification information of the media data to which reproduction rating information is to be applied, and the ‘group’ attribute indicates a group that includes the media data to which the reproduction rating information is to be applied. Although a plurality of pieces of media data are included in one group, according to an embodiment (e.g., left-viewpoint image data and right-viewpoint image data), the reproduction rating information may be different even among the plurality of pieces of media data. Thus, the media data to which the reproduction rating information is to be applied is defined by using the identification numbers of the media data.

In FIG. 17, a ‘Segment_index’ tag 1722 indicates the reproduction rating information for a segment pertaining to media data having identification information of ‘3˜5’, and a ‘Segment_index’ tag 1732 indicates the reproduction rating information for a segment pertaining to media data having identification information of ‘1˜2’.

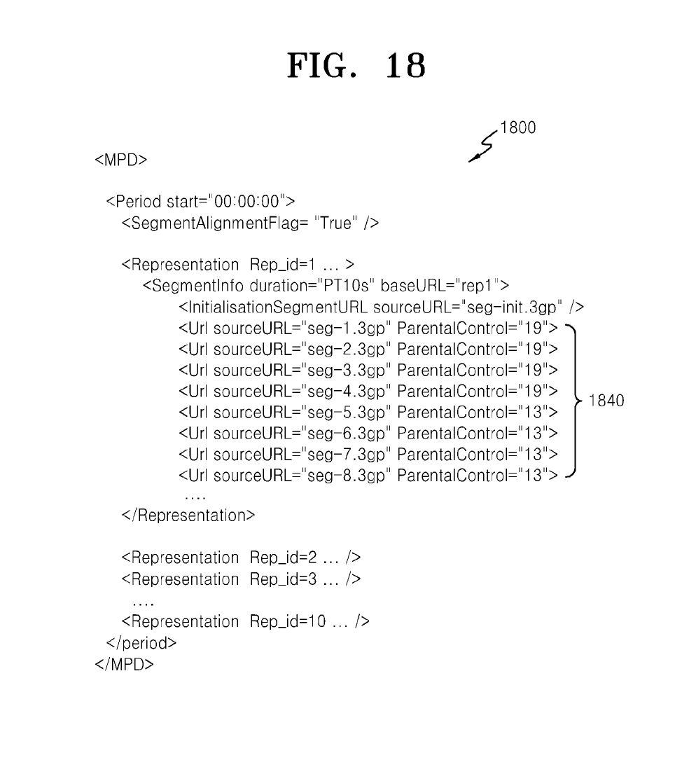

FIG. 18 illustrates an information file 1800 pertaining to media data, according to another exemplary embodiment.

A ‘URL’ tag 1840 includes a ‘sourceURL’ attribute and a ‘parentalcontrol’ attribute. The ‘sourceURL’ attribute indicates the address of a segment, and the ‘parentalcontrol’ attribute indicates the reproduction rating of the segment. In FIG. 18, ‘seg-1.3gp, seg-2.3gp, seg-3.3gp, seg-4.3gp’ are appropriate for reproduction only by users equal to or greater than 19 years of age.

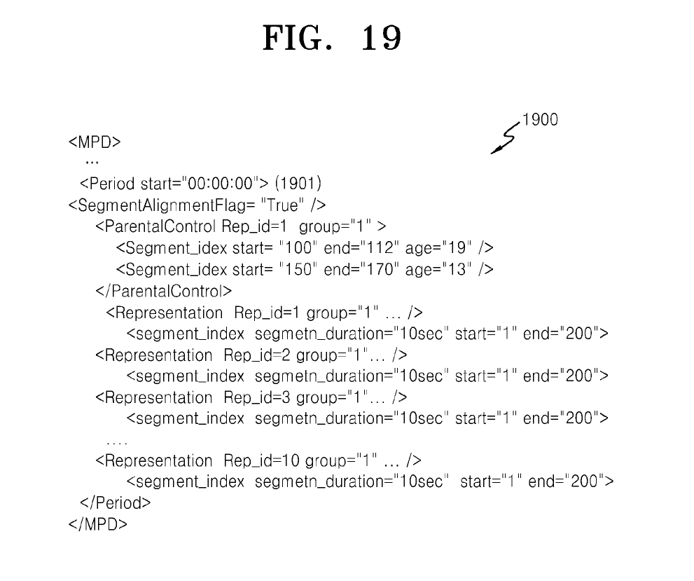

FIG. 19 illustrates an information file 1900 pertaining to media data, according to another exemplary embodiment.

In FIG. 19, a period to which a reproduction rating is to be applied is defined by using both identification information and group information of media data.

Referring to a ‘Parental Control’ tag, it is possible to see that the reproduction rating information is applied to media data which has the identification information of ‘1’ in a group having identification information of ‘1’.

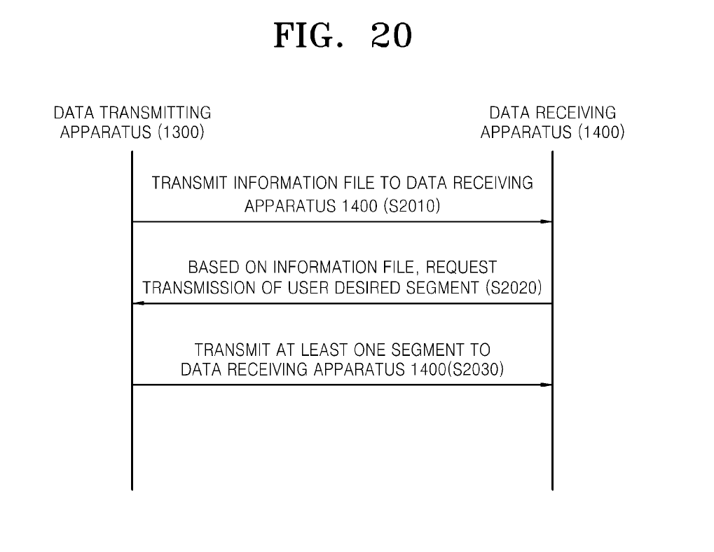

FIG. 20 is a flowchart of operations of a data transmission system, according to an exemplary embodiment.

In operation S2010, the data transmitting apparatus 1300 transmits to the data receiving apparatus 1400 an information file pertaining to a plurality of pieces of media data, included in one group. The information file includes reproduction rating information pertaining to various periods in the media data.

The reproduction rating information includes period information indicating parts of a period that have the same reproduction rating, and the reproduction rating in the period. The reproduction rating information may indicate reproduction ratings pertaining to all the periods in the media data, or may indicate only periods having reproduction ratings equal to or greater than a threshold value. The period information may indicate the location of the period by using numbers indicating the first and last segments in the period, or by using start and end times.

In operation S2020, the data receiving apparatus 1400 requests the transmission of a segment desired by the user, the request being based at least in part on the information file. For example, the data receiving apparatus 1400 may request only segments equal to or less than a previously set reproduction rating.

In operation S2030, the data transmitting apparatus 1300 transmits the requested segment or segments to the data receiving apparatus 1400.

The exemplary embodiments can be written as computer programs and/or instructions and can be implemented in general purpose digital computers that execute the programs and/or instructions using a physical computer-readable recording medium. Non-limiting examples of the computer-readable recording medium include magnetic storage media (e.g., ROM, floppy disks, hard disks, etc.), optical recording media (e.g., CD-ROMs, or DVDs), etc.

While the inventive concept has been particularly shown and described with reference to exemplary embodiments thereof, it will be appreciated that various changes in form and detail may be made without departing from the spirit and scope of the following claims.

What is claimed is:

1. A method of transmitting media data from a server to a client, the media data being formed of a plurality of segments, the method comprising:
transmitting from the server to the client an information file pertaining to the media data, the information file comprising reproduction rating information for each of the plurality of segments;
receiving, at the server, a transmission request sent from the client and indicating one or more requested segments selected from the plurality of segments; and
in response to the transmission request, transmitting to the client the one or more requested segments.

2. The method of claim 1, wherein:
the media data is generated from input content;
the input content is encoded into a plurality of pieces of media data;
the plurality of pieces of media data are generated so as to have different quality levels; and
the information file comprises information pertaining to each of the plurality of pieces of media data.

3. The method of claim 2, wherein the reproduction rating information comprises:
location information pertaining to a period in the media data in which the reproduction rating is the same; and
a reproduction rating pertaining to the period.

4. The method of claim 3, wherein the reproduction rating information comprises location information pertaining only to a period in the media data that has a reproduction rating equal to or greater than a threshold value.

5. The method of claim 3, wherein the location information comprises identification information pertaining to a first segment and to a last segment in the period.

6. The method of claim 3, wherein the location information comprises time information indicating a start time and an end time of the period.

7. The method of claim 3, wherein a start of the period is a random access point.

8. The method of claim 2, wherein the reproduction rating information is commonly applied to all of the plurality of pieces of media data.

9. The method of claim 2, wherein the reproduction rating information comprises identification information pertaining to the media data to which the reproduction rating information relates.

10. A client method for receiving media data that is formed of a plurality of segments, the method comprising:
receiving from a server an information file pertaining to the media data, wherein the information file includes reproduction rating information for each of the plurality of segments from a server;
based at least in part on the reproduction rating information in the information file, sending a request to the server to transmit one or more segments selected from among the plurality of segments; and
receiving the requested one or more segments from the server.

11. The method of claim 10, wherein:
the media data is one of a plurality of pieces of media data and is generated by encoding input content so as to have different quality levels, and
the information file comprises information pertaining to each of the plurality of pieces of media data.

12. The method of claim 11, wherein the reproduction rating information comprises:
location information pertaining to a period in the media data having the same reproduction rating; and
a reproduction rating pertaining to the period.

13. The method of claim 12, wherein the reproduction rating information comprises location information pertaining only to a period in the media data having a reproduction rating equal to or greater than a threshold value.

14. The method of claim 12, wherein the location information comprises identification information pertaining to a first segment in the period and a last segment in the period.

15. The method of claim 12, wherein the location information comprises time information indicating a start time and an end time of the period.

16. The method of claim 12, wherein a start of the period is a random access point.

17. The method of claim 11, wherein the reproduction rating information is commonly applied to all of the plurality of pieces of media data.

18. The method of claim 11, wherein the reproduction rating information comprises identification information pertaining to the media data to which the reproduction rating information relates.

19. A data transmitting apparatus for transmitting media data that is formed into a plurality of segments, the data transmitting apparatus comprising:
a information file transmitting unit that transmits to a client an information file pertaining to the media data, the information file comprising reproduction rating information for each of the plurality of segments;
a request receiving unit that receives from the client a transmission request for at least one of the plurality of segments; and
a segment transmitting unit for transmitting to the client the at least one of the plurality of segments, in response to the transmission request.

20. A data receiving apparatus for receiving media data that is formed into a plurality of segments, the data receiving apparatus comprising:
an information file receiving unit that receives from a server an information file pertaining to the media data, the information file comprising reproduction rating information for each of the plurality of:
a request unit that sends a request to the server for the transmission of one or more selected ones of the plurality of segments, wherein the selection is based at least in part on the reproduction rating information in the information file; and
a segment receiving unit that receives from the server the one or more selected segments.

21. A computer-readable recording medium having recorded thereon a program for executing the method of claim 1.

22. A media server, comprising:
a processor and physical memory under control of the processor;
instructions in the physical memory that enable the processor to carry out operations, including:
encoding input content into a plurality of media data, each being encoded at different quality levels;
dividing each of the media data into one or more media data segments;
preparing an information file that includes reproduction rating information pertaining to each of the media data segments;
in response to a received request, transmitting the information file to a client; and
in response to a request for one or more of the media data segments, sending the requested media data segments to a client.

23. The server as set forth in claim 22, wherein the media data is divided into segments based on a uniform duration.

24. The server as set forth in claim 22, wherein the sending of the requested media data is performed so as to take into account a threshold reproduction rating value.
